(19) United States
(12) Patent Application Publication
(10) Pub. No.: US 2012/0259651 A1
(43) Pub. Date: Oct. 11, 2012

(54) SYSTEMS AND METHODS FOR REMOTE MONITORING, MANAGEMENT AND OPTIMIZATION OF PHYSICAL THERAPY TREATMENT

(75) Inventors: Patrick J. Mallon, La Jolla, CA (US); Andrew E. Senyei, La Jolla, CA (US)

(73) Assignee: FULL RECOVERY, INC., La Jolla, CA (US)

(21) Appl. No.: 13/082,328

(22) Filed: Apr. 7, 2011

(51) Int. Cl. G06Q 50/00

(52) U.S. Cl. 705/2

(57) ABSTRACT

A movement monitoring and management system, comprises a communication interface; a database configured to store treatment information, sensor data, subject information, reporting, and billing information for a plurality of subjects; a server coupled with the database and the communication interface, the server configured to: receive sensor data via the communication interface, the sensor data including data related to certain activities, exercises or movements performed by the subject according to a treatment plan, analyze the sensor data to assess performance with the treatment plan, automatically determine whether the treatment plan is being complied with or not, whether the treatment plan needs to be altered, and whether the subject is progressing, regressing, or a successful outcome is being or has been achieved based on the analysis, and automatically generate and send at least one message to the subject via the communication interface, the message including instructions for the subject related to whether the treatment plan is being performed and complied with or not, whether the treatment plan needs to be altered, and whether the subject is progressing, regressing, or success is being or has been achieved based on the analysis.

### BACKGROUND

1. Technical Field

The embodiments described herein are related to remote monitoring and management of physical activity and movement, and prescribed physical therapy and/or treatment, and the use of data collected remotely to verify the activity and movement, and to assess performance of and optimization of the prescribed treatment.

2. Related Art

Presently, systems for monitoring and managing physical activity and movement, e.g., in relation to physical and rehabilitation therapy, and physical wellbeing are limited. The physical therapy arena provides a good example of the limited capability in this area. When complications involving the musculoskeletal system impair mobility and function, and impair daily activity, there is a need for physical therapy. When physical therapy is required, the services of a licensed physical therapist, or occupational therapist, may be necessary. Often, a patient will first see a physician who would then make a referral to a licensed therapist or simply recommend that the patient perform certain activities, and/or exercises on their own.

Physical activity and exercise is important to one's wellbeing and good health and physical therapy is an important component to health renewal and recovery. Offered in a variety of settings, from the clinic to the home to rehabilitation centers, physical therapy is most commonly used to promote improved musculoskeletal health and functionality. In some patients, the use of physical therapy may also be used to treat cardiac complications, neurological conditions, or other disorders not related to the musculoskeletal system. Many physicians and physical therapists offer comprehensive treatment plans to their patients. While the focus of initial treatment plans is to reduce pain, restore mobility and increase strength, the long term goal is to restore and/or to improve function and maintain one's independence in certain situations.

In many cases of injury, a disease, a condition or post-surgical procedure, a physician may prescribe home physical therapy where exercises are part of a patient's treatment plan. As part of a home treatment plan, the physician may provide the patient with instructions on how to implement the plan and perform the exercises, optimally, safely, and efficiently unsupervised. Or, a prescription for a physical therapy may be prescribed with a qualified and/or licensed health care professional to provide the patient with instructions on how to implement the treatment plan and perform the exercises, optimally, safely, and efficiently unsupervised. For patients who require more in depth treatment a physician may prescribe physical therapy with a qualified and/or licensed health care professional (e.g., a physical therapist) that requires supervised or assisted exercise or use of specific equipment, and where the physical therapist develops the treatment plan for the patient which includes certain activities and/or exercises that can be performed unsupervised at home or other remote location.

In the realm of treatment provided by a physical therapist and/or other healthcare providing professional, treatments for physical therapy may be simple and limited to only the region of the body affected while, for other patients, the therapy may incorporate a variety of services. The most common physical therapy services offered in a clinic, a healthcare professional's office or rehabilitation center can include but are not limited to exercise, weightlifting, ultrasound therapy, phonophoresis, iontophoresis, electrical stimulation, hot-cold packs, low-laser therapy, and even massage therapy.

A prescription for physical therapy should clearly state the purpose and diagnosis of the condition to be treated and any specific treatment instructions for any potential services to be provided along with the frequency and duration as well as any potential contraindications. In addition, a prescription for physical therapy, any weight, movement, activity or range-of-motion restrictions should be included.

As with any medical service, however, the key to optimal health outcome lies in the proper performance and compliance with the prescribed treatment plans. Unfortunately, conventional approaches for monitoring the completion of and adherence to prescribed physical therapy treatment plans are limited, especially when the prescription is to be performed by the patient on his or her own or otherwise unsupervised. In such situations there is presently no way to ensure that a patient performs exercises prescribed in the treatment correctly, completes them as required, or even performs them at all, etc.

As a result, present approaches to physical therapy can suffer from poor or incomplete results. This can present problems in terms of patient outcomes, but also in terms of reimbursement from both public and private payors. For example, Medicare or a private insurer will typically reimburse for physical therapy when a doctor deems it medically necessary; however, reimbursement should only occur when the exercises or treatments are performed, performed correctly and completed. Where a patient is doing the exercises at home or otherwise unsupervised, this can be difficult if not impossible to monitor under conventional approaches. Thus, the current system can be susceptible to poor treatment outcomes and even fraud.

In order to eliminate such situations, the patient can be required to travel to a location such as a clinic, hospital or rehabilitation center for their physical therapy where there is supervision by a therapist or other healthcare provider. But where the treatment and/or exercises can easily be performed at home, this is an unnecessary and inconvenient step that is both costly and time consuming to the patient due to travel to and from appointments and time lost at work. Also, it takes the time of the therapist: Time that could be spent with another patient that may require “hands on” treatment. The increased use of therapists and clinics also raises costs. Thus, conventional approaches to physical therapy do suffer problems of inefficiency.

Moreover, the science of physical therapy is somewhat marginalized due to the lack of accurate measurement tools and the limited amount of objective feedback obtained. In other words, conventional approaches to physical therapy often fail to produce the most optimum treatments for a particular patient or condition resulting in subjective outcomes that are often suboptimal. Such conventional approaches also fail to account for individual progress or lack thereof and are therefore unable to adjust a treatment to reflect the individual's progress and whether treatment goals are being obtained.

In fact, many exercises, modalities, etc., used in physical therapy have been designed and selected over time based on limited and/or anecdotal subjective feedback and inaccurate methods and measurement of outcomes. Accordingly, treatments usually tend to involve exercises and modalities that have been shown to work for broad populations but that are not necessarily optimized for a particular individual, a particular condition, etc. Further, there are no uniform or objective methods for adjusting a treatment plan to account for its effectiveness with respect to a particular patient. In fact, changing or discontinuing a treatment plan without objective measurement and supportive data can lead to an unchanged or worsening state of health resulting in higher costs and potential reimbursement issues.

While the physical therapy arena provides a good example of the limitations with respect to being able to monitor and manage compliance with a physical activity regimens, not to mention limitation with respect to the ability to optimize, customize and measure outcomes with respect to such regimens, similar issues exists with respect to non-physical therapy activity regimes. For example, wellness programs, physical training programs, etc., can suffer the same drawbacks. Further, the ability to monitor and assess the function of individuals with certain neurological conditions and movement disorders is also limited.

### SUMMARY

Systems and methods that allow remote management of movements in order to perform baseline assessments, develop treatment plans, monitor progress and compliance of treatment, adjust and optimize treatment plans, and measure outcomes related to the treatment plans is described herein.

In accordance with one aspect, A movement monitoring and management system, comprises a communication interface; a database configured to store treatment information, sensor data, subject information, reporting, and billing information for a plurality of subjects; a server coupled with the database and the communication interface, the server configured to: receive sensor data via the communication interface, the sensor data including data related to certain activities, exercises or movements performed by the subject according to a treatment plan, analyze the sensor data to assess performance with the treatment plan, automatically determine whether the treatment plan is being complied with or not, whether the treatment plan needs to be altered, and whether the subject is progressing, regressing, or a successful outcome is being or has been achieved based on the analysis, and automatically generate and send at least one message to the subject via the communication interface, the message including instructions for the subject related to whether the treatment plan is being performed and complied with or not, whether the treatment plan needs to be altered, and whether the subject is progressing, regressing, or success is being or has been achieved based on the analysis.

In accordance with another embodiment, a movement monitoring and management system, comprises a communication interface; a database configured to store treatment information, sensor data, subject information, reporting, and billing information for a plurality of subjects; a server coupled with the database and the communication interface, the server configured to: receive sensor data via the communication interface, the sensor data including data related to certain activities, exercises or movements performed by the subject according to a treatment plan, analyze the sensor data to assess performance with the treatment plan, automatically determine whether the treatment plan is being complied with or not, whether the treatment plan needs to be altered, and whether the subject is progressing, regressing, or a successful outcome is being or has been achieved based on the analysis, and automatically generate and send at least one message to a supervisor via the communication interface, the message including information related to at least one of whether the treatment plan is being performed and complied with or not, whether the treatment plan needs to be altered, and whether the subject is progressing, regressing, or success is being or has been achieved based on the analysis.

In accordance with another aspect, a method for movement monitoring and management, comprises receive sensor data via the communication interface in a server, the sensor data including data related to certain activities, exercises or movements performed by the subject according to a treatment plan, the server analyzing the sensor data to assess performance with the treatment plan, the server automatically determining whether the treatment plan is being complied with or not, whether the treatment plan needs to be altered, and whether the subject is progressing, regressing, or a successful outcome is being or has been achieved based on the analysis, and the server automatically generating and sending at least one message to the subject via the communication interface, the message including instructions for the subject related to whether the treatment plan is being complied with or not, whether the treatment plan needs to be altered, and whether the subject is progressing, regressing, or success is being achieved or has been achieved based on the analysis.

These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

FIG. 1 is a diagram illustrating an example system is accordance with one embodiment;

FIG. 2A is a diagram illustrating an example remote location in accordance with one embodiment;

FIG. 2B is a diagram illustrating an example data processing device that can be included in a gateway within the remote location of FIG. 2A;

FIG. 3 is a block diagram of an exemplary motion sensor for use in the system in accordance with one embodiment;

FIG. 4 is a block diagram of a process that can be carried out by the system in accordance with one embodiment;

FIG. 5 is a diagram illustrating an example supervised location in accordance with one embodiment;

FIG. 6 is a block diagram of a process that can be carried out by the system in accordance with one embodiment;

FIG. 7 is a block diagram of a process that can be carried out by the system in accordance with one embodiment;

FIG. 8 is a block diagram of a process that can be carried out by the system in accordance with one embodiment;

FIG. 9 is a block diagram of a process that can be carried out by the system in accordance with one embodiment; and

FIG. 10 is a diagram illustrating an example remote location in accordance with another embodiment.

### DETAILED DESCRIPTION

In the systems and methods described herein, motion sensors, physiologic sensors, or both are methodically tested and correlated with specific activities, exercises, movements, intended outcomes, etc., in order to determine optimized sensor combinations for each activity, exercise and/or movement, and in certain embodiments, for each individual or certain groups of individuals. The sensors are configured to wirelessly communicate with a gateway, which in turn communicates directly or via a Smartphone with a remote server. The gateway can be a dedicated device, a multipurpose device such as a Smartphone, or it can be a dedicated device configured to be attached to the Smartphone. For example, in the physical therapy arena, the sensors can detect when a patient has properly setup and completed an exercise and can transmit such data to the remote server via the gateway. The server can be configured to the correlate this information with treatment compliance, progress, and outcomes and automatically generate various specific reports to be used by healthcare providers, insurers, patients and other third parties. Also, the server can be configured with payment guidelines that can allow the server to automatically bill the proper payor for properly performed exercises, completed treatment plans, and successful or intended outcomes for both reimbursement and non-reimbursement purposes. The systems described herein can also be configured to detect fraud, even where the patient is performing the exercise, but is actually trying to deceive the system.

Algorithms running on the remote server, or in communication therewith can be configured to not only detect proper performance of a prescribed treatment plan but also the effectiveness of the treatment, i.e., whether the patient is progressing, regressing, straining too hard, unable to perform certain exercises, or whether the exercises are too easy or are not producing the intended results, even though there is no fraud and the exercises are being performed properly. Certain algorithms can even suggest new exercises or optimization of the current treatment for the patient or individual, or group of patients or individuals. Thus, the system can provide instant feedback that can be used to continually optimize the treatment plan, and show support for any changes and the effectiveness thereof, all without requiring the patient to visit a supervised location such as a health provider onsite at a clinic or hospital for treatment oversight.

Although, as explained in detail below, an initial visit or consultation is often required in order to perform an evaluation and develop a baseline assessment in order to then develop a custom, individualized treatment plan, which can include a corresponding, personalized avatar. Such an avatar can be a part of the treatment plan used as a guide or instructor/coach for the prescribed treatment. Follow up assessments can also be performed as desired.

It will be understood that the term “treatment plan” is intended to refer to any kind of activity, movement or exercise plan provided to an individual by a supervisor such as a physical therapist, occupational therapist, physician, personal trainer, coach, wellness expert, etc. Thus, while the terms “prescribed treatment” and “prescribed treatment plan” can refer to a treatment or plan that is associated with a prescription from a healthcare provider, it can also simply refer to an exercise regimen or routine provided by an, e.g., personal trainer.

Similarly, in the area of, e.g., wellness, sensors can be configured to provide data related to certain activities, exercise or movements performed by an individual. The server can then determine progress, performance levels and compliance with and completion of, e.g., an exercise plan, can generate messages for the individual or, e.g., a coach, and can determine whether the individual is ready to advance in level or stage, etc., within the plan. The server can also determine whether the plan needs to be updated or changed in other ways as well.

The sensor data can also be used by the server to determine outcome measurement of the success or progress of therapy or treatment, whether in the area of physical therapy, wellness, etc. This type of outcome measurement can be referred to as a “function determination”. Often this will involve data related to strength. Thus, the sensors can include strength sensors configured to transmit data to the server for use in function determination, e.g., the effectiveness of certain exercise in terms of improved strength.

But the function determination can be more complex than simple strength determinations, or determinations that include angle, speed, etc. For example, the function determination can be designed to determine whether an individual can function the way they did before an injury, or whether they are still limited. As such the function determination can involve multiple sensor types, including GPS sensors, physiologic sensors, strength sensors, motion sensors, etc.

Because the system will have access to data from many patients' experiences, the system can even generate a tailored treatment plan that is optimized for a particular need or type of injury or condition and can identify new or different exercises and even treatment plans that can be effective for various conditions and injuries. In fact, the system and algorithms included therewith can be used to find previously unknown relationships between injuries and groups of individuals, other conditions, etc.

In short, the systems and methods described herein represent a revolution in movement monitoring and management that can enable vast improvements in physical therapy, physical training, exercise, recovery from surgery or other trauma, monitoring of movement and neurological disorders, and drug therapy to name just a few areas that can be improved through the systems and methods described herein. Moreover, the ability to gather data and develop data sets representative of various populations can further increase the benefits of the systems and methods described herein. For example, such data sets can improve treatment plan optimization and customization, can allow for in depth trending, alarming, etc., and allow modification of treatment plans based on trending, comparisons to similar populations, etc.

By bringing sensor, communication, analytic and other technologies to bear on the problems and areas described herein, these areas can be revolutionized and the level of treatment and effectiveness can be increased significantly as in other areas of health and medicine.

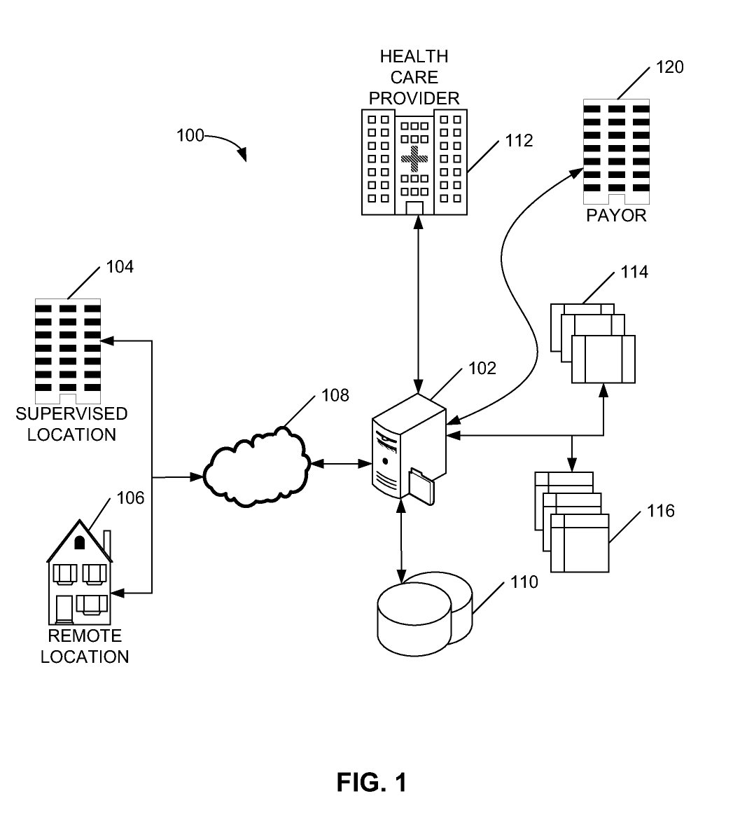

FIG. 1 is a diagram illustrating an example system for monitoring, management and optimization of a movement treatment plan in accordance with one embodiment. While many of the following embodiments deal with the physical therapy environment, it will be understood that application of the systems and methods described herein are not limited to physical therapy but will also have applicability in the areas of, e.g., wellness, exercise, neurological conditions, movement disorders, drug management, etc. Certain example applications in these other areas are also discussed below, but it should be understood that all of the example embodiments described here are by way of example only and are not intended to limit the systems and methods described herein to only certain applications or implementations. Rather, the systems and methods described herein can be applied in a wide variety of applications involving feedback related to movement of the human body alone or in combination with other biometric or physiologic function measurements.

Referring to FIG. 1, it can be seen that system 100 comprises a central server 102 that can be interfaced with at least one supervised location 104 and at least one remote location 106 via a network 108, such as the Internet. Server 102 can actually comprise multiple components and resources. For example, server 102 can comprise multiple servers for redundancy and to carry out various functions. Server 102 can also comprise multiple data base servers, routers, network interfaces, and multiple processors as required. Server 102 can in general comprise all of the hardware and software resources needed to perform the processes described herein.

Supervised location 104 and remote location 106 can communicate via wired or wireless communication interfaces. As used herein, supervised location 104 is a location that a patient or individual (subject) seeks treatment and/or performs a treatment plan or certain activities, exercises or movements while under supervision. Thus, a supervised location can include, but is not limited to a physician's office, a physical therapist's office, a clinic, a hospital, a gym, a rehab center, etc. In contrast, remote location 106 is a location that the subject performs the treatment plan without supervision, e.g., alone. Thus, a remote location can include, but is not limited to a home, an office, a gym, a hotel room, a clinic, a rehab center, a sports field, etc.

It will be understood that network 108 can comprise one or more wired or wireless PANs, LANs, WANs, MANs etc., interfaced as required to enable the communication described herein.

Data gathered at clinic 104 and home location 106 can be transmitted to server 102 where it can be stored in storage system 110. Various algorithms and routines 116 resident on or available to server 102 can be configured to then automatically generate reports 114, analyze data to detect fraud, determine treatment compliance, make function determinations, determine progress and outcomes as well as to generate new or modify treatment plans and generate new prescriptions. Server 102 can also be configured to perform billing operations including but not limited to determining payment and reimbursement amounts, generating invoices, receipts, and payments, etc.

Certain reports 114 can then be made available to a healthcare provider 112, e.g., physical therapist, occupational therapist, physician, personal trainer, coach, wellness expert, etc., to a payor, e.g., a private or public insurance company, Medicare, Medicaid, a third party billing/payment processing company, and/or to the patient as well as to other third parties, e.g. coach. In some embodiments, the payor 120 has direct access to the data, reports, etc. saved on server 102. This promotes a system where the payor 120 is not dependent on the e.g., a healthcare provider 112 or other intermediary to gain access to report information and determine whether payment should be approved or not.

As described below, a patient or individual can be outfitted with one or more sensors designed to monitor the activities, exercises and movements they perform. The sensors can then communicate data related to the activities, exercises and movements, as well as other types of data, to server 102 where it can be stored and analyzed and where reports and messages can be generated, treatment plans assessed and modified, and billing performed as needed.

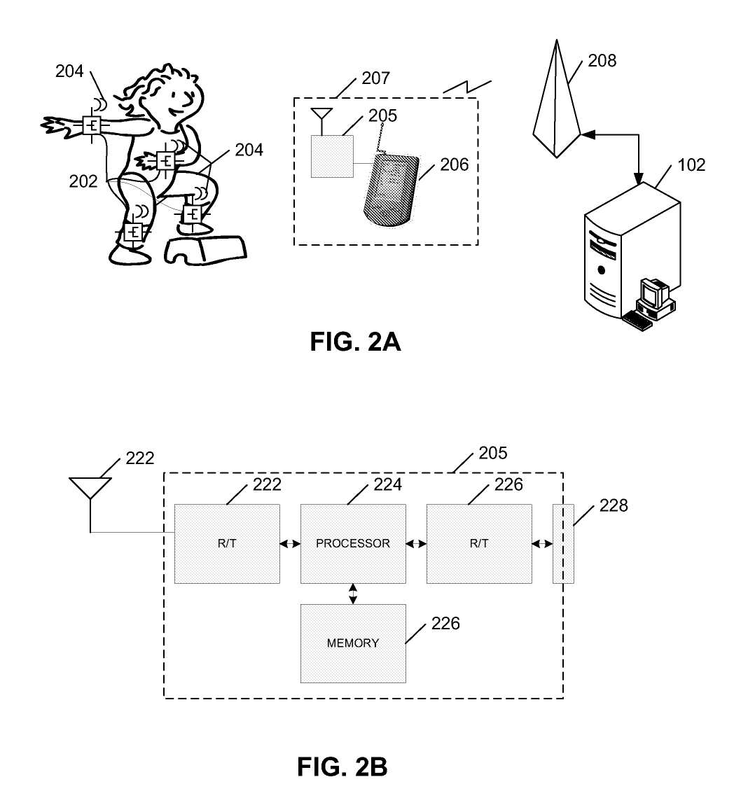

Set up and optimization will be discussed in detail below; however, FIG. 2 is a diagram illustrating an example remote location 106 in accordance with one embodiment. As noted above, remote location 106 can in fact be any location that is remote from the clinic, doctor's office, hospital, or other supervised location 104, etc. In other words, location 106 can refer to a location where activities, exercises and movements are performed in the absence of supervision or direct monitoring by a physical therapist, occupational therapist, physician, coach, trainer, care giver, etc.

Referring now to FIG. 2A, it can be seen that a plurality of sensors 202 can be placed on a patient or individual and can be configure to sense various movements related to activities, exercises or movements that are part of the patient's or individual's treatment plan. While a plurality of motion sensors 202 are shown in FIG. 2, it will be understood that one or more sensors 202 can be used depending upon the treatment plan or activities, exercises and movements performed and where some sensors measure certain physiological functions in addition to movement. Sensors 202 can wirelessly transmit sensed data to a gateway device 207 via wireless signals 204. As such, sensors 202 can comprise wireless transmitters configured to transmit, and in certain embodiments receive wireless signals 204.

The transmitters can, for example, be Radio Frequency (RF) transmitters or Infrared transmitters depending on the embodiment. Moreover, the transmitters can be configured to operate in accordance with any of a plurality of communication protocols, such as various 802.11 standard protocols including various standards that are collectively referred to as WiFi standards, WiGig standards, and UltraWideband Standards. The transmitters can also comply with the ZigBee standard, Bluetooth, and in particular the low power Bluetooth standard, the IRDA standard, various standards or protocols that make use of the industrial, scientific, and medical (ISM) radio band, short-range device (SRD) bands, the European SRD bands, the Chinese WPAN bands as well as various other low power standards designed for short range communication. Specific examples of sensors will be described in detail below.

In some embodiments, gateway device 207 can comprise a data processing device 205 that is attached or tethered to a communication device 206. Communication device 206 can in certain embodiments comprise a cell phone or Smartphone. In some embodiments, data processing device 205 can comprise a data integrator and processor configured to interface with such a communication device. An exemplary type of data processing device is described in U.S. Pat. No. 7,810,729 (the '729 Patent) to Morley, herein incorporated by reference. The '729 Patent relates to a card reader device that is configured to be plugged into a Smartphone and reads magnetic strips from credit cards for payment purposes. The card reader device of the '729 Patent comprises a simple magnetic read head and generates analog signals that can be communicated to, e.g., a cell phone via a jack that can be plugged into the audio input of a cell phone.

While such a jack can be sufficient for the data processing device described herein, it will also be understood that more sophisticated signaling and data communication protocols, e.g., using digital communication techniques can also be employed. For example, cell phones often include USB inputs and other connectors that can be used to interface data processing device 205 with communication device 206.

FIG. 2B is a block diagram illustrating an example data processing device 205 configured in accordance with one embodiment. As can be seen, data processing device 205 can comprise an antenna 220 and receiver/transmitter 222 configured to send and receive information to and from sensors 202 via signals 204. Data processing device 205 can also include processor 224 and memory 226. Processor 224 can be configured to control the operation of device 224 based on instructions stored in memory 226. Memory 226 can also be configured to store data, such as data received from sensors 202, as well as data processed by processor 224 based on algorithms, applications, programs, instructions, etc., which can also be stored in memory 226.

As such, processor 224 can comprise a processor, microprocessor, microcontroller, digital signal processor, math co-processor, etc., as well as some combination or subset of the above. Memory 226 can comprise volatile memory, nonvolatile memory or some combination of the above as well as disk drives, removable memory drives, slots, or interfaces, such as for a SIM card, Flash card, memory sticks, USB memory devices, etc.

Under the control of processor 224, data processing device 205 can be configured to scan multiple sensors including sensors 202 and receive data therefrom. Device 205 can also be configured to aggregate and store the data. In certain embodiments, device 205 can be configured to not only aggregate the data but to also correlate the data, e.g., from different sensors, based on time stamps or other information included in the data. Device 205 can also be configured to filter the data, and to identify critical information, such alarm conditions, most relevant data, etc. It should be noted that device 205 can comprise multiple antenna 220, receiver/transmitters 222, or both in order to aggregate data from multiple motion sensors 202 some of which can be transmitting in one particular frequency band, such as the ISM Band in the 902 to 928 MHz frequency band, while others are transmitting in another frequency band or using a different protocol, such as Bluetooth data, which operates in the 2.4 GHz range. It will also be understood that multiple antennas or receivers can be used to provide diversity to improve reception.

Device 205 can then transmit the data to communication device 206 for transmission to remote server 102. For example, device 205 can include a second transmitter/receiver 226 and a communication interface 228 for transmitting the data to communication device 206. For example, communication interface 228 can be a USB interface or other interface configured to allow device 205 to interface with communication device 206. In other embodiments, interface 228 can also be a wireless interface configured to wirelessly interface device 205 with communication device 206.

Depending on the embodiment, device 205 can transmit all data received from the sensors, only filtered data, only event specific data, or some combination thereof. In certain embodiments, data processing device 205 and communication device 206 can relay data without user intervention or setup, e.g., the data processing device 205 will automatically search for sensors 202, establish a connection, and relay data transmitted by sensors 202 to communication device 206, which will automatically relay the data to server 102. In other embodiments, the user can be required to activate a program on device 205, communication device 206, or both that will then put the devices into a mode whereby they can relay information from sensors 202 to e.g., server 102.

Communication device 206 can accordingly also comprise a transmitter or transceiver capable of communicating with device 205. Additionally, communication device 206 can also comprise a transceiver capable of communicating with server 102. In certain embodiments, for example, communication device 206 can be configured to communicate via the cellular network to a base station 208, which in turn can be interfaced with server 102. It will be understood that FIG. 2 is not intended to imply that base station 208 is directly interfaced with server 102. Rather, FIG. 2 is intended to imply that server 102 can be interfaced with the cellular network that includes base station 208.

As noted, in certain embodiments, communication device 206 can be a mobile communication device, such as a Smartphone. In some embodiments, such as described above, communication device 206 will often act as a simple data relay to relay data gathered by device 205 to server 102. In other embodiments, communication device can be a router or other device capable of acting as a data relay such as the MiFi device from Novatel Wireless.

One advantage of a data processing device 205 is that such a device can be configured to do more than simply relay data. For example, such a device can be configured to automatically scan for multiple sensors, including other sensors, such as scales, heart monitors, cameras, thermistors, pressure sensors, biometric or physiologic sensors, strength sensors, EMG sensors, etc., aggregate data therefrom, correlate data therefrom, and even process the data to determine what data is relevant or to identify a critical data point or event, before transmitting the data. Thus, data processing device 205 can be configured to perform certain processing functions, such as described above, and can also determine the best time to transmit data, e.g., when it is less expensive to do so.

In other embodiments, however, gateway 207 can function as a simple relay of data from sensors 202, negating the need for data processing device 205. In such embodiments, gateway 207 can simply comprise a communication device 206 such as a Smartphone or router.

It will also be understood that while gateway 207 or more specifically communication device 206 is shown communicating with server 102 via the cellular system, in other embodiments, this communication can be via wired communication interfaces.

It should also be noted that in other embodiments, the functionality of data processing device 205 and communication device 206 can be incorporated into a single stand alone device such as a computer or Smartphone.

In still other embodiments, the communication device can be a game box such as a Play Station or X-box type of device. Embodiments that use game boxes are described in more detail below; however, it will be noted here that the prescribed treatment plan may be implemented or acted out with the aid of such a game box. Thus, integration with the game box can be advantageous.

Referring again to FIG. 2, various combinations of sensors can be deployed for use in conjunction with the systems and methods described herein. For example, various motion sensors, strength sensors, physiologic sensors such as heart rate sensors, blood pressure sensors, skin conductance or perspiration rate sensors, temperature sensors, pain sensors and oxygen sensors, etc., e.g., for detecting blood oxygen level, cameras, etc., can be worn, held, attached or tethered to the patient or individual, or external to the patient or users.

Thus depending on the embodiment, one or more motion sensors such as one or more accelerometers, gyrometers, magnetometers, pedometers, cameras or gesture detection devices, etc., or some combination thereof can be attached and/or external to the patient or individual. As noted above, the sensors preferably include wireless communication capability for communicating with gateway 207. Also, because some of the sensors can be worn, held, attached or tethered to the patient, it is desirable for them to be small, lightweight, durable, and include a battery. Many conventional sensors and movement monitoring systems do not meet these requirements.

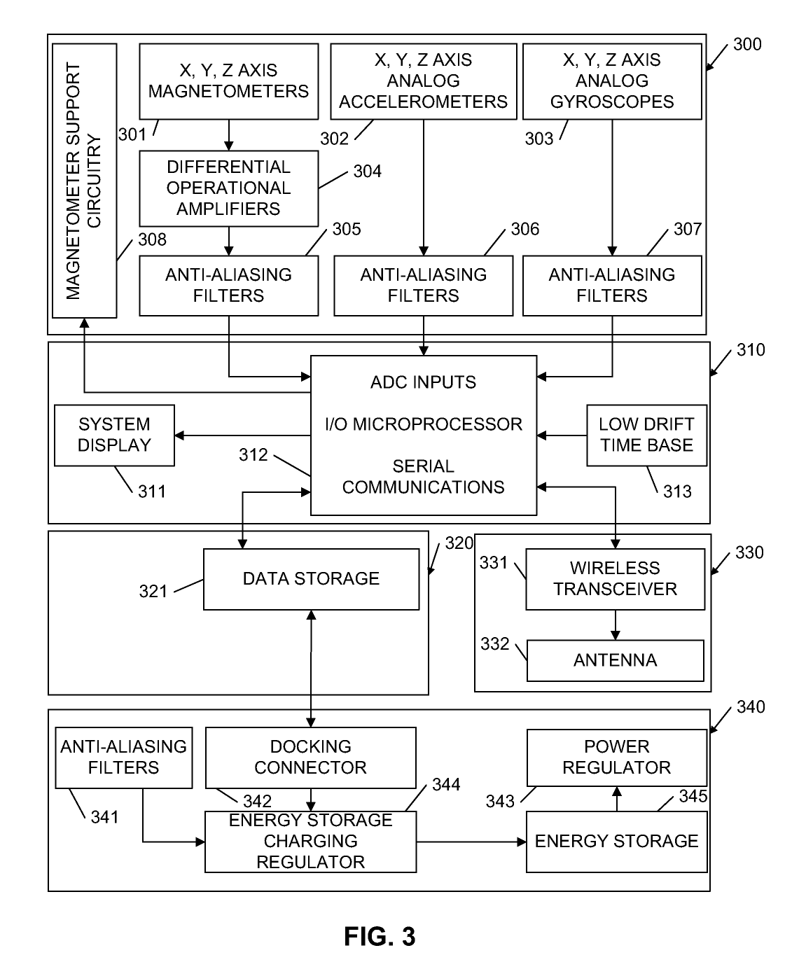

One motion sensor that does meet the requirements is produced by ADPM, Inc., and is illustrated in FIG. 3. The ADPM wearable movement monitor is a lightweight device (<100 g) comprising (a) a sensor module comprising a plurality of low power (<50 mW) solid state and micro-electromechanical systems kinematics sensors; (b) a microprocessor module comprising a low power (<50 mW) microcontroller configured for device control, device status, and device communication; (c) a data storage module comprising a solid state local storage medium; and (d) a wireless communication module comprising a low power (<50 mW) surface mount transceiver and an integrated antenna.

In one embodiment, the micro-electromechanical systems kinematics sensors include a plurality of solid-state, surface mount, low power, low noise inertial sensors including a plurality of accelerometers and gyroscopes, as well as a solid-state, surface mount, low power, low noise, Gigantic Magneto-Resistance (GMR) magnetometers. In a particular embodiment, the solid state local storage medium is substantially equivalent to a high capacity SD card (>4 GB) in order to enable for multi-day (>2 days) local storage of movement monitoring data at high frequencies sampling frequencies (>20 Hz). In one embodiment, the communication module is designed to communicate with a plurality of wearable movement monitors (peer-to-peer communication) in order to synchronize the monitors, and to communicate with a host computer (peer-to-host communication) to transmit sensor data, uses a bidirectional groundplane PCB patch antenna, and accepts transmissions from a plurality of beacons to calculate the device location.

The movement monitor apparatus is a lightweight, low-power, low noise, wireless wearable device with the following characteristics: 1) weight of 22 g, 2) sampling frequency of 128 Hz, 3) wireless synchronization, 4) 14 bit resolution, 5) three-axis MEMS accelerometers (user configurable from 2 g to 6 g), 6) three-axis MEMS gyroscopes with a 1500 deg/s range, 7) three-axis magnetometers with a 6 Gauss range, 7) automatically calibrated, 8) over 16 hours of operation per charge, and 9) over 20 days of onboard storage capacity. The monitor includes solid state, low-power, low-noise sensors as follows: accelerometer (0.001 m/s2/sqr(Hz)), XY gyroscope (p0.01 deg/s/sqrt(Hz)), z Gyroscope (0.1 deg/s/sqrt(Hz)), and magnetometer (170 nT/sqrt(Hz)).

The monitoring continuously records data from embedded sensors. The sensors can be worn at any convenient location on the body that can monitor impaired movement. Convenient locations include the wrists, ankles, trunk, and waist. The sensors include one or more channels of electromyography, accelerometers, gyroscopes, magnetometers, and other MEMS sensors that can be used to monitor movement. The wearable sensors preferably have sufficient memory and battery life to continuously record inertial data throughout the day from the moment subjects wake up until they go to sleep at night, typically 18 hours or more. In one particular embodiment designed for continuous monitoring of movement during daily activities, the device uses a storage element substantially equivalent to an SD card to store movement data for extended periods of time (e.g., 1 month).

With such a monitor there is no need for the user to turn the wearable devices 202 on or off. According to one embodiment, the wearable devices 200 include the components and interconnections detailed in FIG. 3: a sensor module 300, a microprocessor module 310, a data storage module 320, a wireless communication module 330, and a power and docking module 340. An embodiment of each of these modules comprising the apparatus for continuous and objective monitoring of movement disorders is described in detail below. In addition to movement monitoring in clinical applications such as movement disorders, the embodiments disclosed can be use to characterize movement in a plurality of application areas including continuous movement monitoring, activity monitoring, biomechanics, sports science, motion research, human movement analysis, orientation tracking, animation, virtual reality, ergonomics, and inertial guidance for navigation, robots and unmanned vehicles.

The sensor module 300 contains the motion sensors necessary to characterize the symptoms of movement disorders. Three of these sensors are low noise accelerometers 302. According to one embodiment, the accelerometers are off-the-shelf, commercially available Micro-ElectroMechanical Systems (MEMS) acceleration sensors in small surface-mount packages, such as the STMicro LIS344AHL. In other embodiments, the acceleration sensors are custom-made MEMS accelerometers. The accelerometers are arranged in three orthogonal axes either on a single multi-axis device, or by using one or more separate sensors in different mounting configurations. According to one embodiment, the output of the accelerometers 302 is an analog signal. This analog signal needs to be filtered to remove high frequency components by anti-aliasing filters 306, and then sampled by the analog-to-digital (ADC) peripheral inputs of the microprocessor 312. According to one embodiment the anti-aliasing filters are single pole RC low-pass filters that require a high sampling frequency; in another, they are operational amplifiers with multiple-pole low pass filters that may use a slower sampling frequency. In other embodiments, the device includes an analog interface circuit (AIC) with a programmable anti-aliasing filter. According to another embodiment, the output of the accelerometers is digital, in which case the sensor must be configured for the correct gain and bandwidth and sampled at the appropriate rate to by the microprocessor 312.

The next three sensors in the sensor module 300 are solid state, low noise rate gyroscopes 303. In one embodiment, the accelerometers are off-the-shelf, commercially available Micro-ElectroMechanical Systems (MEMS) rotational sensors in small surface-mount packages, such as the Invensense IDG-650 and the Epson Toyocomm XV-3500CBY. Other embodiments include custom-made MEMS. The gyroscopes are arranged in three orthogonal axes either on a single multi-axis device, or by using one or more separate sensors in different mounting configurations. According to one embodiment, the output of the gyroscopes 303 is an analog signal. This analog signal needs to be filtered to remove high frequency components by anti-aliasing filters 307, and then sample by the analog-to-digital (ADC) peripheral inputs of the microprocessor 312. According to one embodiment the anti-aliasing filters are single pole RC low-pass filters that require a high sampling frequency; in another, they are operational amplifiers with multiple-pole low pass filters that may use a slower sampling frequency. In other embodiments, the device includes an analog interface circuit (AIC) with a programmable anti-aliasing filter. According to another embodiment, the output of the gyroscopes is digital, in which case the sensor must be configured for the correct gain and bandwidth and sampled at the appropriate rate to by the microprocessor 312.

The sensor module 300 also contains one or more aiding sensors. According to one embodiment, an aiding system is a three axis magnetometer 301. By sensing the local magnetic field, the magnetometer is able to record the device's two axes of absolute attitude relative to the local magnetic field which can aid correcting drift in other inertial sensors such as the gyroscopes 303. In one embodiment, the magnetometer sensors are off-the-shelf, low noise, solid-state, GMR magnetometer in small surface-mount packages such as the Honeywell HMC 1043. In other embodiments there are custom-made MEMS. The magnetometers 301 are arranged in three orthogonal axes either on a single multi-axis device, or by using one or more separate sensors in different mounting configurations. According to one embodiment, the output of each magnetometer 301 is an analog signal from two GMR magnetometers arranged in a Wheatstone bridge configuration, which requires a differential operational amplifier 204 to amplify the signal and an anti-aliasing filter 305 to remove high frequency components. These amplified, anti-aliased filters 305 are then sampled by the analog-to-digital (ADC) peripheral inputs of the microprocessor 312. According to one embodiment the anti-aliasing filters 305 are single pole RC low-pass filters that require a high sampling frequency; in another, they are operational amplifiers with multiple-pole low pass filters that may have a slower sampling frequency. In other embodiments, the device includes an analog interface circuit (AIC) with a programmable anti-aliasing filter. Unlike conventional MEMS inertial sensors, magnetometer sensors 301 may need considerable support circuitry 308, which in one embodiment include such functions as temperature compensation of the Wheatstone bridge through controlling the bridge current, and low frequency magnetic domain toggling to identify offsets through the use of pulsed set/reset coils.

Although not specifically depicted in the sensor module 300, other aiding sensors could be added. In one embodiment, a Global Positioning System Satellite Receiver is added in order to give absolute geodetic position of the device. In another embodiment, a barometric altimeter is added to give an absolute indication of the vertical altitude of the device. In another embodiment, beacons consisting of devices using the same wireless transceiver 331 could also tag specific locations by recording the ID of the beacon.

The microprocessor module 310 in FIG. 3 is responsible for device control, device status, as well as local data and communication processing. The microprocessor 312 may indicate the device's status on some kind of visual or auditory display 311 on the device. In one embodiment, the display 311 is a red-green-blue (RGB) light emitting diode (LED). In another embodiment, a small LCD panel is used to display information, such as the time of day, and system status such as battery charge level.

According to one embodiment, the microprocessor 312 is a low power microcontroller such as the Texas Instruments MSP430FG4618. The microprocessor coordinates the sampling of sensors, data processing, data storage, communications, and synchronization across multiple devices. The microprocessor should be a lower power device with enough computational resources (e.g., 20 MIPS) and input/output resources (more than 20 general purpose input/output lines, 12 analog-to-digital converter inputs, more than two serial communication ports, etc) to interface to other modules.

The microprocessor is clocked by a low drift time base 313 in order to accurately maintain both a real time clock (RTC) and to minimize drift in the synchronous sampling across multiple devices on one subject over long periods of time. In one embodiment, the low drift time base 313 is a temperature compensated crystal oscillator (CTXO) such as the Epson TG3530SA. In another embodiment, the time base 313 is a standard microprocessor crystal with custom temperature compensation using the digital-to-analog converter of the microprocessor 312. Using a CTXO instead of a standard microprocessor crystal also minimizes power consumed by the wireless communication module 330 since the frequency necessary to re-synchronize devices is reduced.

In addition, to the utilization of a temperature compensated crystal oscillator, a master time code will be sent wirelessly to the sensors 202 from the gateway 206 if a gateway is present or from a particular sensor 202 which has been selected as the master sensor time code distributor if a gateway is not present. Distribution of a master time code will be done on a periodic bases in addition to beginning of a physical therapy session and will reduce the time difference between sensors 202 during the physical therapy session where the accuracy of the time codes used for time stamping the sensors 202 data is essential to the control algorithms used for the physical therapy session.

The data storage module 320 stores the measurements from the sensors 300 and status of the device (such as the energy storage device's 345 charge level) locally on the device in data storage 321. It is especially designed to support studies involving multi-day continuous movement monitoring. In one embodiment, the device is capable of storing movement data at a sampling frequency of 128 Hz for over 20 days. In one embodiment, the local data storage 321 is Flash memory soldered to the device's printed circuit board. In another embodiment, a high capacity Flash card, such as a >4 GB MicroSD card, is used with a high speed synchronous serial port (SPI) from the microprocessor 312 to minimize wire complexity and to enable a standard protocol to hand or to a host computer as necessary. In another embodiment, the data storage module 320 is greatly reduced, or even unnecessary, because data is streamed directly of the device using the wireless communication module 330.

The wireless communication module 330 allows the device to communicate to other devices (peer-to-peer), to a host computer (peer-to-host) and to listen to other data such as wireless beacons. The wireless communication module 330 serves multiple functions: it broadcasts data from the device's inertial sensors 300 to a computer or other recording device, it synchronizes sampling rate across multiple devices through a sampling time synchronization protocol, and allows for configuring the devices behavior (i.e. mode of operation). Another use for the wireless communication module 330 is to listen for transmissions from beacons which inform the device about its current location (e.g. bathroom, kitchen, car, workplace, etc). In one embodiment, the communication protocol is an industry standard protocol such as Bluetooth, ZigBEE, WiFi or substantially equivalent protocol. In another embodiment, it is a custom communication protocol based on a physical layer transceiver chip.

One embodiment of the wireless communication module 330 consists of a low power, 2.4 GHz surface mount wireless transceiver 331, such as the Nordic Semiconductor nRF24L01+. The wireless transceiver 331 uses a small on-board antenna 332, such as a chip antenna like the gigaNOVA Mica antenna for both transmitting and receiving wireless communications. In another embodiment, the antenna 332 is a groundplane PCB patch antenna. In one embodiment, the wireless transceiver 331 uses a high speed synchronous serial port, such as the serial peripheral interface (SPI), to communicate with the host microprocessor 312. In another embodiment, the wireless transceiver 331 is built into the microprocessor 312 as a peripheral.

Another embodiment of the wireless communication module 330 consists of a low power wireless transceiver 331, such as the Atmel AT86RF212 operating in the 779 to 787 MHz band for the Chinese WPAN, the 863 to 870 MHz band for the European SRD band, and 902 to 928 MHz band for the North American ISM Band. The wireless transceiver 331 uses a small on-board antenna 332, such as a chip antenna like the gigaNOVA Mica antenna for both transmitting and receiving wireless communications. In another embodiment, the antenna 332 is a ground plane PCB patch antenna. In one embodiment, the wireless transceiver 331 uses a high-speed synchronous serial port, such as the serial peripheral interface (SPI), to communicate with the host microprocessor 312. In another embodiment, the wireless transceiver 331 is built into the microprocessor 312 as a peripheral.

In another embodiment, the wireless transceiver 331 uses skin conduction to create a Personal Area Network (PAN) instead of a broadcast radio. Another embodiment uses light, such as infrared light, as a wireless communication system like the industry standard IRDA. In this last embodiment, the antenna 332 would be an optical transceiver.

A benefit of using a sensor such as that described above is that it can allow detection of motion in the up and down and right to left planes as well as rotational movement, all in a single compact device. But it will be understood that the sensor described above is presented by way of example only and is not intended to limit the embodiments described herein in any way.

In addition to motion sensors, strength or force measuring sensors can also be worn, held, attached or tethered to the patient or external to the patient and used alone and in conjunction with the motion sensors. For example transducers, dynamometers, pressure or other sensors can be used to measure patient or user strength, which as explained below can be used to measure outcome or to make a function determination.

Additionally, biometric or physiologic function sensors such as heart rate sensors, blood pressure sensors, perspiration rate sensors, temperature sensors, pain sensors and oxygen sensors, etc. can be used alone and in conjunction with the motion sensors. These sensors can be worn, held, attached or tethered to the patient or user or external to the patient or users.

An Electromyography (EMG) sensor or sensors can also be used. EMG data can be important for measuring muscle contractions or activity, assess nerve conduction and muscle response in an injury, movement disorder or neurological disease or condition. EMG sensors in some cases can help to detect neurological disorders and differentiate, e.g., muscle weakness due to a muscle condition from muscle weakness caused by a neurological disorder.

Thus, sensors 202 can provide movement data indicative of range of motion, number of movements, timing, etc.; strength, e.g., pressure or exertion; physiological function e.g., heart rate sensors, blood pressure sensors, perspiration rate sensors, temperature sensors, pain sensors and oxygen sensors to gateway 206. This information can be transmitted to server 102 where various algorithms described in more detail below can use the data to determine, e.g., compliance, technique, treatment progress, and even outcome.

As mentioned above, sensors 202 can then communicate data related to the exercises and/or movements, e.g., the sensor data, to server 102 where it can be stored, processed and analyzed and where reports can be generated, billing performed, etc. Referring again to FIG. 1, it can be seen that server 102 can be interfaced with database(s) 110, which can be configured to store patient or individual information including a name or identifier, age, sex, weight, height, geography, race, symptoms, condition, goal, history, diagnosis or injury, type of surgery or procedure, etc., and such information can be anonymized and can be stored and managed in compliance with HIPAA regulations. In situations involving a diagnosis, known condition, injury, or type of surgery or procedure, database 110 can be configured to also store corresponding CPT codes, ICD-9 code, etc., and insurance plan information, which can be used for reimbursement and payment as described below.

Database 110 can also be configured to store treatment plan information including, e.g., both prescriptions for physical therapy or rehabilitation. For example, in the case of prescriptions, database 110 can store prescription information based on the type treatment requested for an injury or procedure performed as well as for a particular condition where rehabilitation is required. Similarly, in the case of treatment plan information more generally, database 110 can store both standardized treatment information based on the injury or procedure performed or a particular condition as well as individualized prescriptions information. Even in the area of wellness or exercise plans, database 110 can store both standardized wellness and/or exercise information based on the health status, condition, injury, or procedure performed as well as individualized treatment plan information.

In addition, database 110 can be configured to store individualized baseline assessment information for specific patients or individuals as well as a population-based, standardized baseline information, e.g., based on studies of various populations or multiple patients and/or patient types, e.g., patient populations.

Database 110 can also be configured to store billing and payment information including personal billing and payment information as well as third party billing and payment information, including billing and payments for Medicare, private health insurers, etc.

Database 110 can also be configured to store reports related to patients or individuals, or groups of patients. For example, these reports can be for use by the patient or individual, healthcare provider, insurance provider, billing and/or payment processing company, or by another third party.

Database 110 can also be configured to store automated messages or notifications sent to patients or individuals, healthcare providers, insurers, and other third parties to effect new prescriptions, generate or modify treatment plans, reports, or billing and payments.

Server 102 can be configured to then use algorithms 116 to perform various analysis and processes on and using the data stored in database 110. For example, algorithms 116 can enable server 102 to generate instructions to modify and/or optimize prescribed treatment plans.

Algorithms 116 can also allow server 102 to make decisions based on the sensor data and other information stored in database 110. For example, these decisions can be related to acceptable performance of activities, exercises and movements, e.g., in accordance with a prescribed treatment plan; unacceptable performance of exercises and movement; advancement of level or stages within a treatment plan; non-advancement of level or stages within a treatment plan; and determination of outcome.

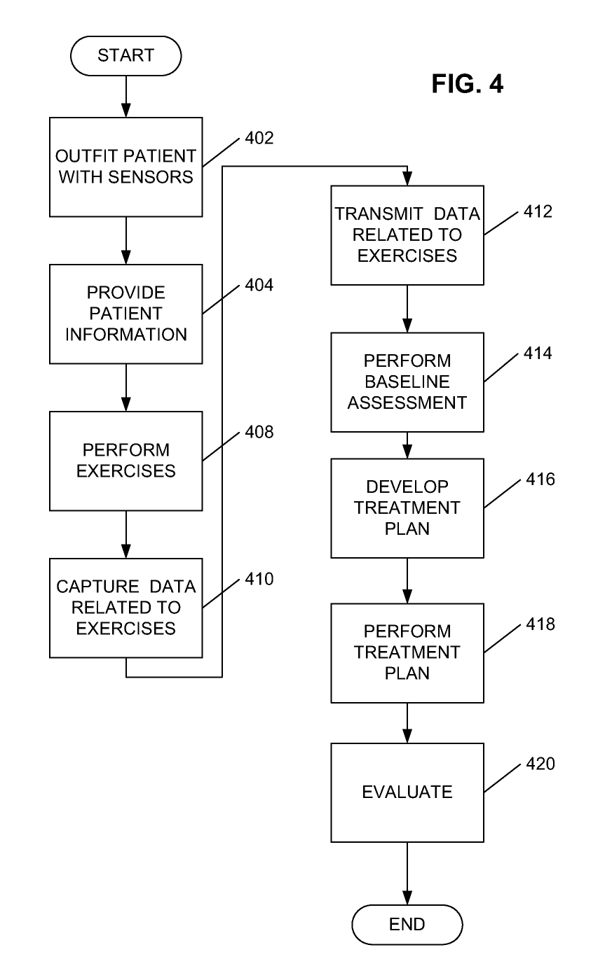

Additionally, database 110 can store algorithms or applications that enable server 102 to generate feedback, instruction, intervention, or compliance messaging as well as targeted advertising that can be sent to the patient or individual, healthcare provider, insurance provider, etc., as well as to manage billing, payments and reimbursement. FIGS. 4-9 and the descriptions that follow describe some of the processes that can be carried out by server 102 using algorithms 116 as well as detailed examples of movement management and monitoring the can be performed within system 100.

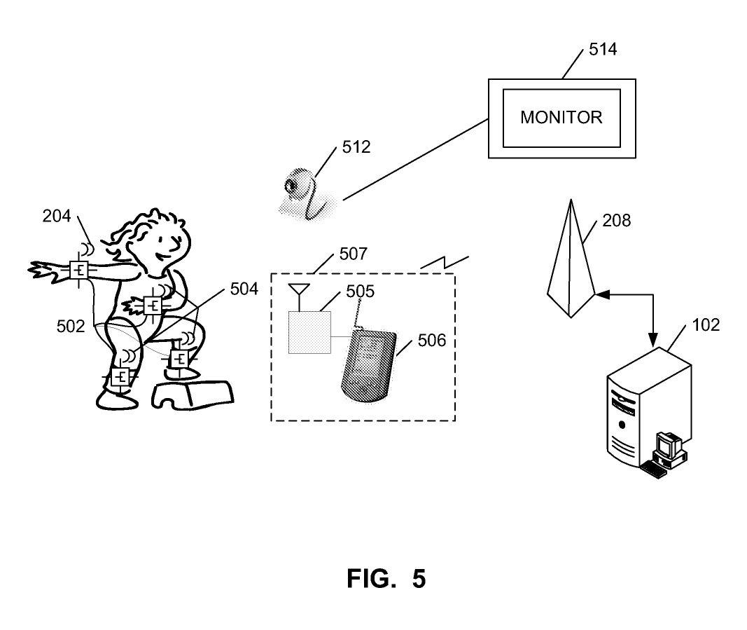

First the process of evaluation and baseline assessment will be discussed with respect to FIGS. 4 and 5. As will be seen, a baseline assessment can involve the creation of an avatar that can then be used later on for visual instruction, feedback and motivation as well as final stage assessment. A patient or individual can be required to visit a supervised location 104 for baseline assessment. For example, in the case of physical therapy, a prescribing healthcare provider, e.g., a physician can provide a “prescription” for physical therapy to the patient in his or her office for a specific, individualized treatment plan for the patient or the patient can take it to another healthcare provider, e.g., a physical therapist, whom then develops a specific, individualized treatment plan for the patient. In other words, the, e.g., physician or physical therapist can evaluate a patient and develop a specific, individualized treatment plan based upon the patient's particular circumstances.

In the supervised location, the patient or individual can be outfit with a plurality of sensors 502 in step 402. Sensors 502 can be similar to those described above, e.g., sensors 502 can include motion sensors, including a camera or gesture detection/recognition device, strength sensors, and physiologic sensors such as heart rate sensors, blood pressure sensors, perspiration rate sensors, temperature sensors, pain sensors and oxygen sensors. It is important to note that a camera or gesture detection/recognition device can be used as a motion sensor, instead of or in addition to the ability to use a camera for avatar creation and visual feedback. In fact, in certain embodiments, a camera(s) can be used as the sole motion sensor(s). In other embodiments, the camera can be used in conjunction with other motion sensors that detect movement.

A healthcare provider, e.g., physical therapist, occupational therapist, physician, personal trainer, coach, wellness expert etc., can then provide to remote server 102 via a gateway 507, which can be the same or similar to gateway 207 described above, patient identifying information associated with the patient or individual that can then be stored by server 102 in database 110 in step 404. The, e.g., physician or physical therapist can run an application either on or interfaced with gateway 507 for capturing and communicating the patient information.

For example, the supervisor, e.g., the physician or physical therapist can use a computer, Smartphone, PDA, tablet device, etc., interfaced with or comprising gateway 507 to input patient identifying information and perform other functions related to baseline assessment and patient record setup in step 404. This information can, for example, include name, prescription information, diagnosis, codes, etc.

The term diagnosis can be used to refer to what would be considered more conventional diagnosis information such as information related to an injury, condition, symptoms, and a physical history, e.g., related to an injury or procedure such as a surgical procedure. In addition, the diagnosis information can include CPT or ICD-9 code information. But the term diagnosis can also be used to refer to an objective, goal, target, etc., for example, in the case of health and fitness or wellness. In other words, the term diagnosis can be used to refer to the objectives, goals, targets, etc., exercise plan or more broadly a treatment plan created by a personal trainer or wellness expert.

In step 408, the patient or individual can then perform certain activities, exercises or movements as requested by the supervisor designed to ascertain data related to, e.g., range of motion, strength, stress, exertion, capacity, etc. The exercise or movements can be specific activities, exercises or movements designed to ascertain this information or they can be activities, exercises or movements that are part of a standardized treatment plan for a particular diagnosis, certain injury, condition, wellness objective, etc.

In step 410, sensors 502 can transmit data captured during performance of the activities, exercises or movements to server 102 through gateway 507. Server 102 can then analyze the data and use the data in step 412 to perform a baseline assessment and to generate an individualized treatment plan in step 414. In certain embodiments, the e.g., physical therapist, occupational therapist, physician, personal trainer, coach, wellness expert, etc., can also input information, e.g., in the form of comments, observations, recommendations, etc., which can also be used by server 102 to generate the baseline assessment, individualized treatment plan, or both.

The data from sensors 502 can be sent directly through gateway 507 or first to the computer, tablet, PDA, Smartphone, etc., being used by the supervisor to input information.

Further, a camera or gesture detection/recognition device 512 can also capture images of the patient or individual, either in addition to data captured by sensors 502 or in lieu thereof, which can also be transmitted to server 102 and used for evaluation and baseline assessment, development of an individualized treatment plan, or both, or for use as a guide or instructor/coach for the prescribed treatment.

Camera 512 can also be used to provide visual feedback via monitor 514. For example, camera 512 can capture still images or video of the patient or individual for replay and instruction on a Smartphone, tablet, or computer, etc. which can be accessed by the patient or individual, a healthcare provider or other third party. In other embodiments, e.g., where gateway 507 includes a game box, the patient or individual can be playing a game or running a program that displays content on monitor 514 and reacts to the patient's movements.

In step 416, the supervisor, e.g., physical therapist can develop a treatment plan based upon the activities, exercises or movements performed in step 408. More specifically, the treatment plan can be developed automatically by server 102 and algorithms 116 using the data provide in step 408, previously gathered data, e.g., from literature, patients, patient studies, etc., or both. Alternatively, the treatment plan can be developed more organically based on direct input of a specific exercise or treatment plan. In still other embodiments, the treatment plan can be developed based on a combination of the two.

In step 418, the individual can then perform the treatment plan developed in step 416 with aid of the supervisor. Data can again be captured in step 420 and sent to server 102 for use in monitoring, treatment management, compliance, feedback, etc. Also, it is at this time an avatar of the patient or individual can be generated

With respect to avatar creation, the video image of the patient or individual can be captured using a camera 512 while performing the treatment plan or exercises. The image data can be transmitted directly to server 102 or to a local device, such as a computer, tablet, etc., and an avatar of the patient can be developed. If the avatar is created locally, then it can be sent to server 102 where it can be processed and returned back to gateway 502. The patient can then have access to the avatar as it can be seen on the Smartphone, tablet or computer and is used as a guide or instructor/coach for the prescribed treatment.

With respect to baseline assessment of step 414, once the data has been collected in step 410 and sent to sever 102, server 102 can as noted use that data to perform the baseline assessment.

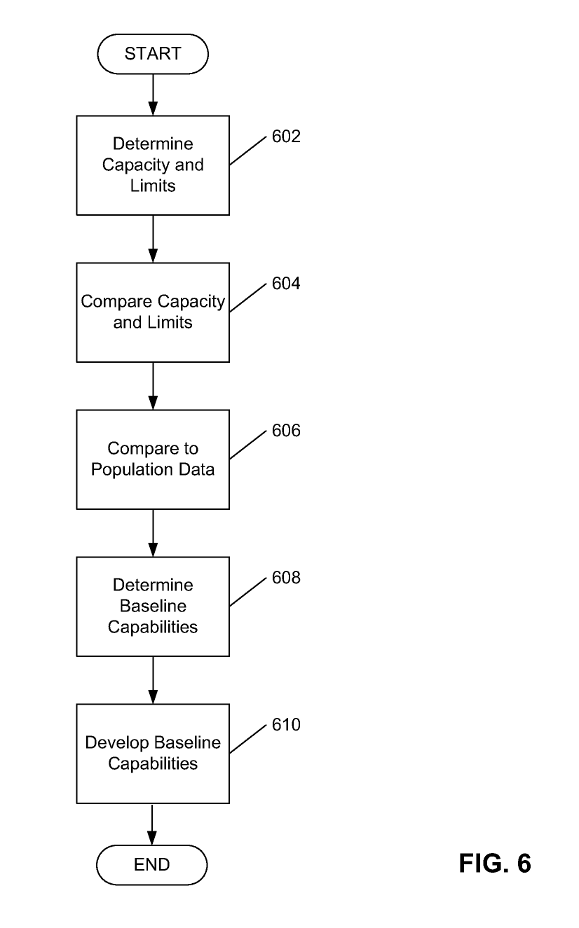

FIG. 6 is a flow chart illustrating the process of evaluation and baseline assessment. First, in step 602, server 102 can use the data to determine an individual's capacity to perform certain activities, exercises or movements and to determine ranges and limits with respect to weight, speed, repetition, frequency, pain, etc. In step 604, server 102 can compare the capacity and limit information determined in step 602 with standard exercise and treatment plans in order to determine possible modifications thereto. Also, in step 606, server 102 can compare the data and capacity and limit information with data for a population of individuals for which similar data has been acquired. In some embodiments, the capacity and limitation information is prematurely capped so that an individual does not risk further injuring himself if they were to perform the exercises incorrectly.

This can allow server 102 to determine baseline capabilities in step 608 and to develop an individualized treatment plan in step 610. The custom treatment plan can, for example, include modification to a standard treatment plan, e.g., based on the patient's or individual's data and based on the comparison to others within the similar population. Server 102 can also be configured to use information related to custom treatment plans for other individuals with similar traits, e.g., capacity and limits, to develop a customized or individualized prescription to plan for the individual being evaluated.

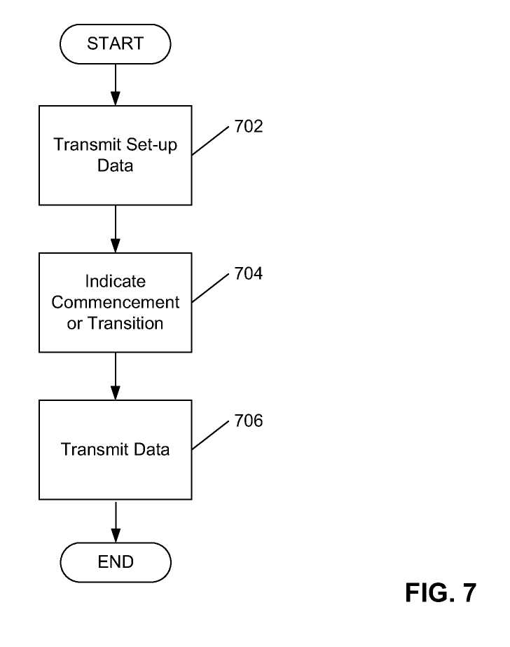

In other embodiments, baseline assessment can be skipped and the patient or individual can simply be given a preconceived, standard treatment plan. In such embodiments, baseline assessment can then be integrated into monitoring of the activities, exercises or movements as the patient or individual begin performing the treatment plan. Modification or adjustment and optimization to the treatment plan can then occur as the patient is monitored while performing the treatment plan and the data is transmitted to server 102 as described below. Once a patient or individual has received an individualized treatment plan, the individual can then perform the activities, exercises or movements defined by the treatment plan unsupervised at their remote location 106. Performance of the activities, exercises or movements can then be monitored and recorded in order to determine compliance, assess outcome, determine advancement to the next phase, etc., as illustrated in the flow chart of FIG. 7 at which time modification or adjustment to and optimization of the treatment plan can then occur. First, in step 702, sensors 202 can be configured to obtain and transmit data with respect to how the patient or individual sets up to perform certain activities, exercises or movements. This set up can include the actual deployment and configuration of sensors 202 as well as body position, posture, etc.

In certain embodiments, an application running on gateway 207 or interfaced with gateway 207, such as on a laptop, tablet or other personal computer, can be activated and synchronized with the patient's or individual's performance of the activities, exercises or movements. For example, the individual can activate the program, which can then automatically inform server 102 via gateway 207 that the individual is performing set up. Alternatively, the patient or individual can manually indicate setup performance via input into the program. Once set up is complete, then the user can indicate the beginning of the treatment plan via the program. In certain embodiments, the user can also indicate transition from one movement or exercise to another, the beginning of a new repetition, etc. In other embodiments, the application or server 102 can automatically detect the commencement of the treatment plan, transitions from one activity, exercise or movement to another, new repetitions, etc., based on the sensor data, e.g., by turning the sensors 202 on or by initiation of the program. Thus, in step 704, the patient or individual can indicate the commencement of a first activity, exercise or movement or transition to another exercise or movement or repetition as required.

As the patient or individual performs various activities, exercises or movements, sensors 202 can detect and transmit data related thereto in step 706. This data can include, time frame information, e.g., how long did it take to perform a movement, as well as data related to the movement such as range of motion, number of movements, etc. For example, sensors 202 can track the movement of the individual's hand, arm, leg, torso, etc., while performing a particular activity, exercise or movement.

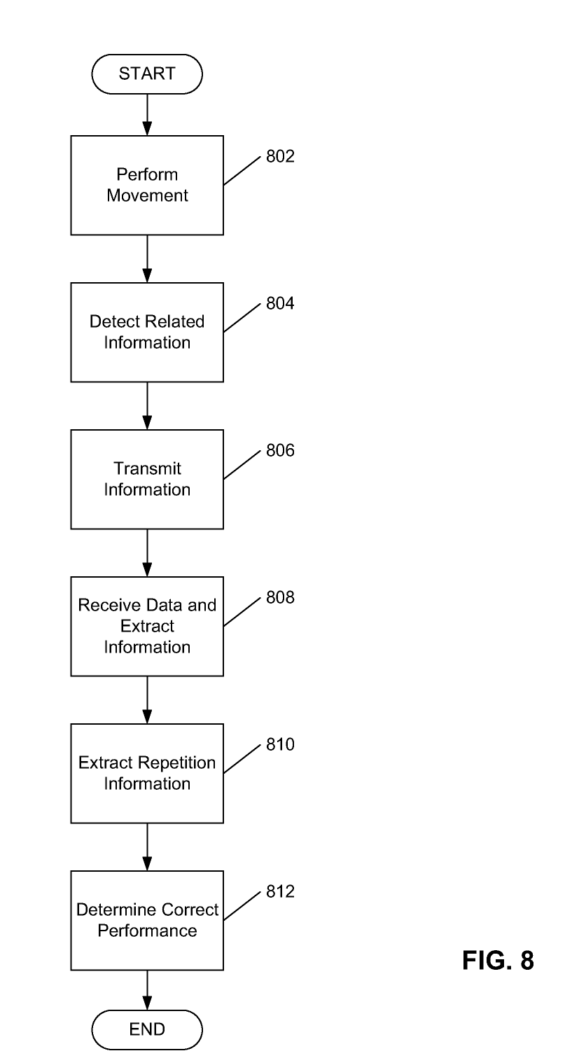

Once server 102 has obtained the sensor data, it can use the information for various purposes including compliance detection, performance assessment, treatment plan optimization, etc. as illustrated in the flow chart of FIG. 8. Compliance in this sense is intended to mean compliance with the treatment plan in terms of performing the activities, exercises or movements outlined in the treatment plan. This can also encompass whether the individual performed the activity, exercise, or movement correctly, e.g., has a range of motion associated with the exercises, has a hold time associated with the exercises, has an exertion level associated with the exercises, has interval information associated with the exercises, where the interval is a time period between repetitions or a time period between sessions, etc. As explained below, this information can be used for use by insurers for reimbursement purposes as well as for analysis and use by healthcare providers.

Referring to FIG. 8, in step 802, the user can perform an activity, exercise or movement as prescribed and sensors 202 can detect information related to the movement in step 804. In step 806, sensors 202 can transmit the data to server 102 via gateway 207. As described above, in certain embodiments, gateway 207 can collect, aggregate, and even process the data before sending depending on the particular embodiment.

In step 808, server 102 can receive the data and extract timing and movement information, and in step 810 server 102 can extract repetition and other information. Server 102 can then use this information, in step 812, to determine whether the movements were performed correctly, whether the proper sets and repetitions, etc. were performed, and also whether any equipment, weights, etc., were set up correctly.

In certain embodiments, server 102 can include or can be configured to work in conjunction with various algorithms 116 designed to assess, manage and optimize the performance of a patient or individual when performing the treatment plan. For example, the algorithms 116 can use the data provide by sensors 202 to determine whether the patient or individual properly or improperly performed the activities, exercises or movements that are included in the treatment plan. The algorithms 116 can also be configured to determine whether the patient or individual is adhering to his or her treatment plan, whether the patient or individual is ready to advance to a new level, whether the treatment plan needs to be modified and adjusted, or even whether some kind of alarm condition such as over-exertion exists while the patient or individual is performing the activities, exercises or movements. In some embodiments, this may require the integration of other sensors 202 such as physiologic sensors, including heart rate sensors, blood pressure sensors, perspiration rate sensors, temperature sensors, pain sensors and oxygen sensors, etc., strength sensors, or even a camera or gesture detection/recognition device.

Thus for example, the algorithms can determined whether something is wrong, even if the exercises are being performed correctly, e.g., as determined in step 808. Moreover, the analysis performed by algorithms 116 in this regard can use not only the data currently, or recently transmitted by sensors 202, but also data related to the patient or individual that has been stored over time. This way, algorithms 116 can assess progress, or regression, as well as effort, and outcomes, etc., by comparing the current data to past data. The availability of historical data also allows server 102 to determine whether proper progress is being made over time and whether the treatment plan needs to be updated, adjusted and optimized or a new prescription is necessary from a prescribing healthcare provider, e.g., a physician.

In fact, algorithms 116 can be trained to identify trends, patterns, etc., in the data, which can allow algorithms 116 to predict future results, problems, progression, etc. This can enable server 102 to suggest and even require and make changes, modifications, adjustments, advancements, etc., automatically in a timely fashion so that the treatment plan can constantly be optimized to meet the patient's or individual's needs and goals. It can also allow server 102 to predict and avoid problems.

Moreover, data for a large population of patients or individuals can be available to server 102 and algorithms 116, which can increase the predictive ability of algorithms 116. Thus, algorithms 116 can be configured to mine data for a plurality of individuals and to assess patterns, trends, correlations, etc., and to apply them to the data being received from sensors 202 for a given patient or individual. Algorithms 116 can then use this analysis to predict or forecast results for the patient or individual, to predict or forecast required changes, modifications, etc., to the treatment plan; to determine progress; to determine whether the patient or individual is ready to advance to another level; etc.

The data for the patient or individual can then be incorporated with the population data and can further enhance the predictive ability of algorithms 116. This information can also be used, as described above, to make informed baseline assessments generate individualized treatment plans as well as to update, adjust and optimize treatment plans.

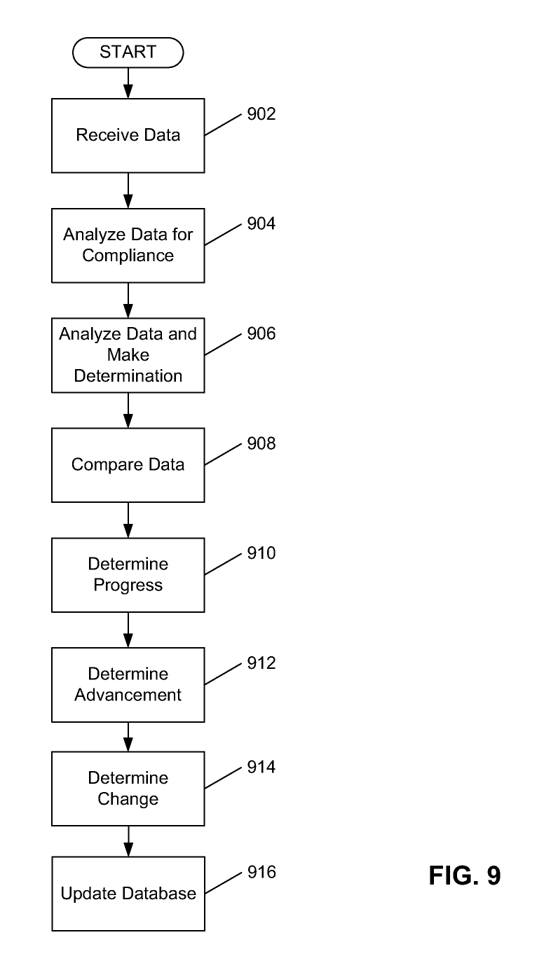

With this in mind, FIG. 9 is a diagram illustrating an example process for analyzing the sensor data in accordance with one embodiment. First, in step 902 sensor data is received from sensors 202, e.g., via gateway 207. In step 904, the data can be analyzed to determine compliance with the associated treatment plan. In addition, a determination can be made as to whether the patient or individual is progressing, or regressing (step 910); whether the patient or individual is ready to advance to a next level within the treatment plan (step 912); whether the treatment plan needs to change (step 914); etc. As explained, this can be done by simply analyzing the data in step 906 or, as illustrated in step 908, by comparing the data to past data for the patient or individual, or a combination of steps 906 and 908.

In step 916, the sensor data can be added to database 110 and can be added to the population data used in step 908, depending on the embodiment.

It is important to note that as server 102 receives increasing amounts of data about a patient or individual, algorithms 116 can be designed to learn about the patient, their rate of progress, their capabilities, capacity, etc. This is especially true when additional sensors 202 such a physiologic sensors, strength sensors, etc., are included with motion sensors 202. The ability to learn about an individual allows algorithms 116 to increase their predictive capabilities and the ability for algorithms 116 to suggest changes and modification to the treatment plan in order to meet the patient's or individual's ongoing needs. This ability also increases as information across a larger population is used and integrated into the process.

Referring back to FIGS. 1 and 2, in some embodiments, system 100 includes the ability to provide feedback and or messaging to and/or between interested parties 104, 106, 112, 120, etc. For example, a patient or individual at remote location 106 performing various activities, exercises or movements in accordance with his or her treatment plan can receive a feedback message in auditory, textual or image form on or through, e.g., gateway 207 that the patient or individual is not performing the exercises correctly. This feedback message can be provided directly from server 102 by comparing the patient's or individual's incoming data from sensors 202 against his or her currently prescribed treatment plan or historic or population data stored in storage system 110. In some embodiments, the sensors 202 themselves can be configured to provide an indication to the server 102 that the patient or individual is performing the exercises incorrectly—such as if the sensors 202 send satisfactory signals 204 intermingled with a certain threshold of unsatisfactory signals.

In other embodiments, the healthcare providers, payors, patients, etc., are able to access the data sent from the patient or individual and stored in storage system 110 remotely from any location that has internet access by entering particular patient or anonymized identification information or alternatively, by reviewing reports 114 generated by algorithms 116. From reviewing the data, the supervisor, e.g., the health care provider such as a physical therapist, occupational therapist, physician, personal trainer, coach, wellness expert, can determine if the patient or individual is performing his or her exercises properly in accordance with his or her current treatment plan. If the patient or individual is not performing the exercises properly or not performing the exercises at all, the supervisor, or even the payor, can send a message to the patient or individual on e.g., gateway 207, indicating that the patient or individual is not adhering to the prescribed treatment plan and that there may be consequences should the patient or individual not begin performing according to the plan. Alternatively, the message may be a request that the patient or individual contact his or her supervisor to determine if there is a problem with the current treatment plan.

But it can be preferable for server 102, or more specifically algorithms 116 running thereon to determine compliance, progress, or lack thereof, make determinations with respect to advancement, e.g., to a next or higher level, make determinations with respect to changes in the treatment plan, or components thereof, etc. Thus, as data is collected from sensors 202, algorithms 116 can analyze the data and determine whether any changes relating to the treatment plan need to be made and messages need to be sent to the patient or individual. These treatment plan changes and messages can be more real time, e.g., the sensor or camera data may indicate that the subject is not performing an exercise properly, e.g., does not have proper posture or is not making a movement properly. The sensor data may also indicate that the subject has completed the proper amount of repetitions or sets or not, the subject is ready to advance to a next level, the subject is straining too much, the subjects vital signs are out of an optimal or acceptable range, etc. With respect to drug administration, the sensor data may indicate a problem causing server 102 to immediately generate a message for the patient or a care provider.

Thus, in some embodiments, algorithms 116 can perform manipulation and/or extractions on data collected from the plurality of sensors and use this information to make inferences on how the patient or individual is performing or progressing with his or her current treatment plan. For example, if the patient or individual is running, rather than jogging, as in the above example, the algorithms can detect how hard the patient or individual is working (e.g., running) and send a message to the patient or individual that if he or she continues to exercise at the current rate, that the exercise time should be changed from x, where x is some duration of time, to a fraction of x.

Algorithms 116 can then generate real-time or near real-time messages as the subject is performing aspects of the treatment plan to help guide them and keep them safe, while hopefully still challenging them or helping them to advance, heal, etc. These messages can be sent to the subject or in certain instances a care provider.

In other embodiments, the algorithms can monitor and analyze the data from sensors 202 and generate non-real time changes relating to the treatment plan. For example, after a subject completes a set of activities, exercises or movements in accordance with a treatment plan or a portion thereof, algorithms 116 can analyze the data and make determinations as to whether the subject should advance or alter the activities, exercises, or movements in some manner the next time they are to perform part of the treatment plan, whether the treatment plan should be modified, etc.

Accordingly, an automated feedback loop can be created between the patient or individual and server 102 that results in messages being generated and sent to the patient in order to guide them through their treatment plan, continually challenge them, ensure progression, avoid over exertion, detect problems, etc. The feedback can be based not just on the data generated by sensors 202, but based on historical data for the subjects as well for a population of subjects that bear some relation to the particular subject. Moreover, the data can be from motion sensors, cameras, physiologic sensors, strength sensors, etc., allowing algorithms 116 the ability to analyze numerous variables and make determinations, assessments, etc.

Server 102 can be configured to also communicate with the subject's healthcare provider, insurer, coach, etc., to keep them informed of progress, issues, changes, etc. Reports can also be generate that can be stored on server 102 for access by these various parties. The analysis can also be used for billing and reimbursement.

If there is a problem with the patient's or individual's current treatment plan, the patient or individual may be requested server by 102, or by the healthcare provider, insurer, etc., to return to supervised location 104 to be evaluated again and have another assessment performed or perform his or her treatment plan under supervision to determine where the problem in the plan lies, e.g., if it is the actual plan or the patient's or individual's technique

If server 102 or the healthcare provider, depending on the embodiment, determines that the patient or individual is performing the current treatment plan properly and seems to be showing improvement, e.g., improved range of motion, and/or strength, 102 can send a message to the patient or individual with an updated treatment plan or a new prescription for additional, continued treatment, e.g., if the number of original visits have been completed and more visits have been prescribed. This has the benefit of allowing the patient or individual to advance in his or her treatment without requiring the patient or individual to return to the supervised location 104 or health care provider's office 112 multiple times for the progress assessment or supervised treatment. For example, if a patient or individual has performed his or her exercises according to his or her treatment plan for a certain duration of time and/or based on the information sent by sensors 202 indicating that the patient's or individual's e.g., range of motion or strength has improved, 102 can determine that the patient or individual is ready to advance to a new or modified treatment plan.

Additionally, as noted server 102 or the supervisor, i.e., healthcare provider can provide feedback to the payor, e.g., a private or public insurance company, Medicare, Medicaid, a third party billing and/or payment processing company, etc. letting the payor know if the patient or individual should be reimbursed for his or her adherence or successful completion to the treatment plan. In other embodiments, the insurance provider, Medicare, worker's compensation, or other payor will know, via information provider from server 102, if the patient or individual is performing the exercises properly. Thus, based on this information, the payor can determine whether to reimburse the patient or individual or the healthcare provider.

If however, the patient or individual is not performing his or her exercises in accordance with the current treatment plan, and there is not a valid reason for not performing the exercises, payment or reimbursement may be withheld by the payor. The patient or individual may then be billed directly. This refusal to reimburse allows the payor to avoid simply paying out to patients or individuals who are fraudulently using physical therapy. Additionally, this also prevents payors from paying healthcare providers that do not follow up with the patient or individual to make sure that the patient or individual is making progress.

Again, it should be appreciated that, as shown in FIG. 1, the payor 120 has direct access to e.g., the reports 114 and data saved on server 102. Therefore, the payor 120 can determine independently and direct from the information on the server 102 whether to reimburse or pay for, e.g., a particular patient or individual. The feedback then is a secondary source of information that the payor 120 may use at its discretion.

While the above section has described the messaging as being related to whether the patient or individual is performing the prescribed treatment plan correctly or incorrectly, it should be appreciated that many other types of messaging may be provided to interested parties. For example, in some embodiments, the patient or individual can receive a message generated by, e.g., server 102 or gateway 206, that the patient or individual should begin performing his or her prescribed activities, exercises or movements at a certain time. In other embodiments, the patient or individual may receive a message indicating that the patient or individual is taking too long between repetitions. Still, in other embodiments, the patient or individual may receive a message indicating that the health care provider would like the patient or individual to come in for a second evaluation. There are virtually endless reasons why patient or individual or other interested parties may receive feedback or messaging in system 100.

Additionally, as described above, the motion sensors, physiologic sensors, and/or strength sensors can be combined with sensors 202 in order to provide a more complete or comprehensive understanding of the patient's or individual's performance and/or health according to his or her current treatment plan. For example, if a physiologic sensor such as a heart rate sensor is used in conjunction with a motion sensor on the patient's or individual's wrist, and the patient's or individual's treatment plan is to jog moderately in place for a duration of time, then if the motion sensor detects big movements indicative of a large arm swing and the heart rate sensor detects a higher than preferred heart rate indicative of the patient or individual sprinting instead of jogging or that repetitions of deep knee bends are to slow or too fast, the combination of the sensor data informs the server 102 that the patient or individual is not performing the exercise in accordance with the treatment plan, e.g., the patient or individual is sprinting rather than jogging. The use of multiple sensors in combination allows system 100 to determine if the patient or individual is performing the correct activity, exercise or movement speed, etc., which is not always possible with just the use of a single sensor 202 or with the use of multiple sensors independently, e.g., when the data from the sensors are not combined or cross-referenced, e.g., based on time stamps, etc. However, when multiple sensors' data is combined or cross-referenced by e.g., by gateway 207 or server 102, more information, e.g., whether the patient or individual is experiencing excessive exertion, excessive pain, lack of exertion, new symptoms, etc., can be derived, such as in the above example.

Furthermore, in some embodiments, it can be advantageous to include a strength sensor along with sensors 202. In some embodiments, the strength sensor can comprise a pressure detecting sensor, which can be incorporated into a motion sensor 202. For example, if a patient or individual is performing an exercise such as doing a bicep curl and there are one or more sensors 202 located on the patient's or individual's arm, e.g., such as on the wrist or on the bicep itself, then the sensor 202 can detect the movement when the sensor 202 is moved, by virtue of the bicep curl, and the strength sensor can detect the pressure exerted by the patient or individual, by virtue of the patient's or individual's muscle pushing against the sensor.

In alternate embodiments, the strength sensor can be separate from the motion sensor 202. For example, in some cases the strength sensor can comprise a dynamometer or pressure sensor that the patient or individual exerts a force on upon completion of, e.g., an exercise set or the entire exercise, or at various time intervals. Thus, the patient or individual can, e.g., squeeze a resistance-type sensor or push down on a pressure-detecting button in order to determine and/or assess the patient's or individual's strength.

Such a strength sensor can also be configured such that is can send data to server 102 via gateway 207. This strength information that the sensors send to server 102 similarly can be manipulated or processed by algorithms 116 in order to determine if the patient or individual is performing or progressing with his or her current treatment plan. For example, if the strength information obtained by sensors 102 on a particular patient or individual are compared against population data and it is derived that the particular patient or individual is not progressing, e.g., gaining strength, at a rate within reason, e.g., within 2 sigmas of the mean population strength data, then the current treatment plan can be modified, so that the patient or individual will likely begin to progress at a rate within reason. For example, if the patient or individual is not gaining strength properly, then exercises that promote an increase in strength, e.g., additional or different exercises, can be prescribed.

Also, in addition to physiologic and strength sensors, in some embodiments it may be desirable to include a camera or gesture detection/recognition device for use in performing a baseline assessment, and monitoring a patient's or individual's activities, exercises or movements. For example, the camera may provide video with audio feedback, and may be used in the avatar creation. In some embodiments, the camera is a three-dimensional camera or a red-green-blue (RGB) camera. The camera may be configured to include depth measurements such that when capturing the image of a patient or individual, the camera can store and project the patient or individual image onto a display (e.g., monitor 514) as defined by the depth constraints. The camera may also be configured to include an audio component, such that any sounds made by the patient or individual e.g., during performance of an exercise, can be stored and included with the patient or individual projection onto the display.

Again, it should be noted that a camera or gesture detection/recognition device can also be a motion sensor and can be used in conjunction with other motion sensors 202, alone, or in combination with other types of sensors, e.g., physiologic sensors.

In some embodiments, the camera or gesture detection/recognition device may also be configured to assist in fraud detection. For example, facial recognition software can be included on server 102 or on a local device. Images from the camera can then be input into the facial recognition software, which can be configured to evaluate the images to determine things like assertion, stress, effort, pain, etc. This information can then be used along with the other types of sensor data described above for evaluating the appropriateness of a treatment plan, whether the plan needs to be modified, whether the patient or individual is ready to advance or not, etc. But in addition, the facial recognition software can also be configured to determine whether the patient or individual is trying to “fake out” the system and is not really performing the activities, exercises or movements. This is a type of fraud detection that can lead to a refusal to reimburse.

Another type of fraud detection that can make sue of the facial recognition software is the ability to detect that the person performing the treatment plan is the person to whom the treatment plan has been prescribed, e.g., by detecting facial features of the patient or individual during the initial consultation in the supervised location 104 and by comparing the facial features of the user performing the exercises at home.

In some embodiments, a system for monitoring, management and optimization of a treatment plan that includes certain activities, exercises or movements as described herein can incorporate a game or system such as a Wii, Play station, X-box, etc. It will be understood that many such systems now offer games that react to motions or movements performed by the user. Many such systems use a controller that includes sensors configured to sense how the player moves the controller. This movement is then translated into action in the game, i.e., the swinging of a player's tennis racquet, the rolling of a bowling ball, etc. Some such game systems include boards or platforms that the player stands on and that are configured to sense weight shift and movement of the lower legs, which again are translated into corresponding action in the game. Other systems include sensors that attach to various body parts and that sense motion, such as running, jumping, etc. that can again be translated into action in the game. And still other systems use a camera trained on the user and that uses depth information in order to recognize gestures and movements that can again be translated into action in the game.

In certain embodiments, such gaming systems can be used in conjunction with the systems and methods described herein. In other words, the gaming system, i.e., the sensors, controllers, cameras, etc., can act as the front end system for sensing movement and other information. This information can then be transmitted to server 102 for assessment, evaluation, processing, storing, etc., as described above. Thus, the game box or controller can either communicate with a gateway (207, 507) or can in some embodiments act as the gateway itself.

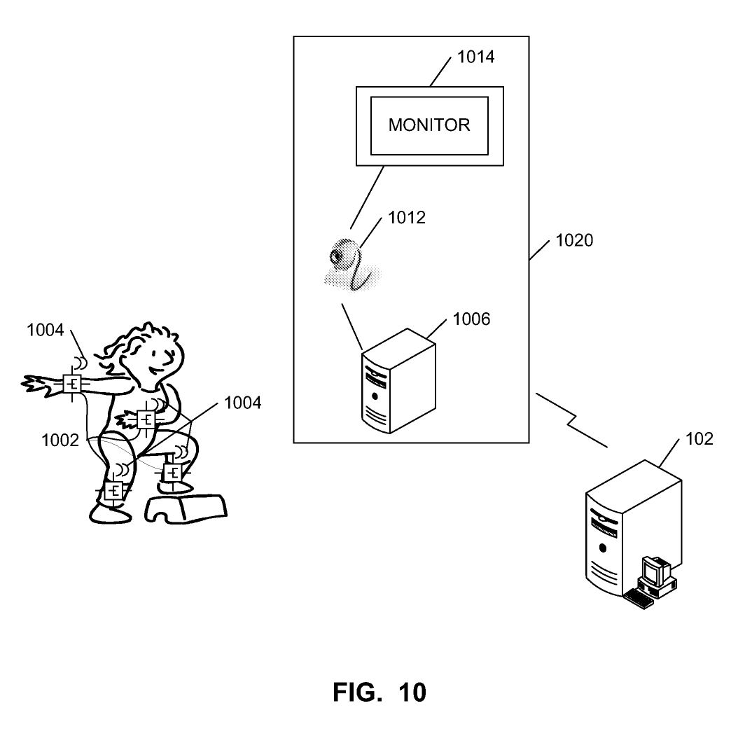

FIG. 10 is a diagram of a system for monitoring, management and optimization of a treatment plan that includes certain activities, exercises or movements and that incorporates an interactive gaming system 1020 and environment in accordance with one embodiment. As can be seen, one or more sensors 1002 can be placed on a patient or individual that can sense various movements related to motions and exercises being carried out in accordance with a treatment plan or game sequence. Sensors 1002 can wirelessly transmit sensed data to a game box or controller 1006 via wireless signals 1004. It will be understood that while sensors 1002 are illustrated as being attached to various parts of the body, the sensors can also be worn, or instead include controllers, such as a Wii controller, boards or platforms that the individual stands on, or some combination of all of the above.

Further, in some embodiments, a camera 1012 can be used capture images of the patient or individual, which can also be transmitted to gaming computer 1006 and used to determine movement, etc. For example, U.S. Patent Publication No. 2010/0199228, entitled “Gesture Keyboarding,” which is incorporated herein by reference in its entirety as if set forth in full, describes a gaming system that uses depth cameras to recognize gestures and movements. Such a system can be included in interactive gaming system 1020. The information obtained by camera 1012 and sensors 1002 may be used collaboratively, or a camera can, in certain embodiments, eliminate the need for sensors 1002.

Movements detected by sensors 1002, camera 1012, or both can then be translated into action depicted on monitor 1014.

This information can also be communicated to server 102 either wirelessly or via a wired connection. In the example of FIG. 10, the data is illustrated as being communicated to server 102 directly from interactive gaming system 1020, i.e., the game box 1006 is acting as the gateway. But again, in other embodiments, the game box 1006 can be interfaced with a gateway such as described above, which can in turn communicate the data to server 102.

Thus, gaming computer 1006 can comprise a transmitter or transceiver capable of communicating with sensors 1004. Additionally, gaming computer 1006 can also comprise a transceiver capable of communicating with server 102.

Several other feature and aspects of the systems and methods described herein should be noted. First, while embodiments dealing mostly with wellness, physical therapy, and rehabilitation have been discussed and described above, it will also be understood that the systems and methods described herein can also be applied in other areas, including for monitoring and detecting a lack of activity or immobility, movement disorders, drug therapy, and for monitoring gait and balance.

For example, post surgery or injury, such as in the case of rotator cuff or shoulder surgery, etc., the patient may be required to remain inactive or immobile. While the embodiments above described ways to detect movement and motion, the same systems and methods can be used to monitor the lack of movement or immobilization of a patient or body part. Messaging can still be used to communicate with the patient when movement or activity has been detected in such situations. Also, as time passes, the system can determine that some amount of movement is ok, and maybe even desired, and therefore the systems and methods can be employed to change the treatment plan, i.e., to allow or maybe even suggest some movement.

Further, the systems and methods described herein can be used to assess disease status for diseases such as Parkinson's disease, Spasticity, Dystonia, and Huntington's disease.

The systems and methods described herein can also be used to help manage drug treatment by allowing the drugs effect to be monitored to see of is causing shaking or other reactions over time that can indicate an incorrect dose. Thus, the systems and methods described herein can assist in determining the correct dose, and ensuring that such has been administered.

The systems and methods described herein can also be used to monitor gait and balance, e.g., post surgery to monitor and detect problems with recovery and to ensure that the patient's gait is returning to normal. If ones gait is not returning to normal, then this can affect other musculoskeletal functions as well as balance. So the ability to detect issues early on can be very useful.

Further, the ability to detect an individual's gait and balance over time, particularly in older individuals, can also be very useful, e.g., for identifying increased risks of a fall, or other potential issues.

Another aspect that should be noted in relation to the systems and methods described herein is the capability of correlating between sensors 202 and exercises or movements. Because the systems and methods described herein can provide data and analysis for a large variety of movements, sensors, and individuals, the data collected can be used to identify new activities, exercises and movements that had previously not be associated with certain conditions, injurious, desired outcomes, etc. In other words, algorithms 116 can be configured to identify better combinations, or alternative exercises for use in various treatment plans.

Moreover, algorithms 116 can be configured to identify which sensors are optimal for acquiring data for different types of activities, exercises or movements. In other words, once a large enough knowledge base has been obtained e.g., by population data, particular patient or individual data, etc., specific combinations of sensors 202 and/or activities, exercises or movements that would be the best for treating e.g., a particular injury or modifying a current treatment plan can be more readily determined. Thus, the system can include a further learning component that can help assist physicians, physical therapists, etc. in providing a treatment plan to a patient or individual that is based on what has been learned over time.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed:

1. A movement monitoring and management system, comprising:
a communication interface;
a database configured to store treatment information, sensor data, subject information, reporting, insurance, payment, and billing information for a plurality of subjects;
a server coupled with the database and the communication interface, the server configured to:
receive sensor data via the communication interface, the sensor data including data related to certain activities, exercises or movements performed by the subject according to a treatment plan,
analyze the sensor data to assess performance with the treatment plan,
automatically determine whether the treatment plan is being complied with or not, whether the treatment plan needs to be altered, and whether the subject is progressing, regressing, or a successful outcome is being or has been achieved based on the analysis, and
automatically generate and send at least one message to a supervisor via the communication interface, the message including information related to at least one of whether the treatment plan is being performed and complied with or not, whether the treatment plan needs to be altered, and whether the subject is progressing, regressing, or success is being or has been achieved based on the analysis.

2. The movement monitoring and management system of claim 1, wherein the sensor data includes data gathered by motion sensors.

3. The movement monitoring and management system of claim 2, wherein the sensor data includes at least one of range of motion data, distance, repetition data, and timing data.

4. The movement monitoring and management system of claim 1, wherein the sensor data includes data gathered by physiologic sensors.

5. The movement monitoring and management system of claim 4, wherein the sensor data includes at least one of heart rate data, blood pressure data, oxygen saturation data, perspiration rate, temperature, pain level, and EMG data.

6. The movement monitoring and management system of claim 1, wherein the sensor data includes image data captured by a camera.

7. The movement monitoring and management system of claim 6, wherein the image data comprises at least one of video or still image data.

8. The movement monitoring and management system of claim 1, wherein the sensor data includes data gathered by a strength sensor.

9. The movement monitoring and management system of claim 1, wherein determining that an alteration in the treatment plan is needed includes determining whether the subject is ready to advance to a new level within the treatment plan, or whether the subject needs to revert to a previous level within the treatment plan.

10. The movement monitoring and management system of claim 1, wherein the message indicates that the subject is not performing an activity, exercise or movement correctly.

11. The movement monitoring and management system of claim 10, wherein the message is related to the subject's posture or position while performing the activity, exercise or movement.

12. The movement monitoring and management system of claim 10, wherein the message is generated or sent in real-time or near real-time.

13. The movement monitoring and management system of claim 10, wherein the message is related to the subjects pace or stride while performing an activity, exercise or movement.

14. The movement monitoring and management system of claim 10, wherein the message is related to the subjects gait or balance while performing an activity, exercise or movement.

15. The movement monitoring and management system of claim 10, wherein the message is related to the amount of strain the subject is under while performing an activity, exercise or movement.

16. The movement monitoring and management system of claim 10, wherein the message is related to a range of motion for an activity, exercise or movement performed by the subject.

17. The movement monitoring and management system of claim 10, wherein the message relates to whether or not the subject's vital signs or other physiological parameters are within an acceptable or optimal range or not.

18. The movement monitoring and management system of claim 10, wherein the message relates to whether the subject is ready to advance a level in the treatment plan or no or has completed the treatment plan.

19. The movement monitoring and management system of claim 1, wherein the supervisor is a healthcare provider.

20. The movement monitoring and management system of claim 1, wherein the subject is logged into or otherwise in communication with a server or system operated by the supervisor, and wherein the message further indicates that the patient is properly logged into or in communication with the server or system operated by the supervisor.

21. The movement monitoring and management system of claim 1, wherein the server is further configured to send a message to a payor.

22. The movement monitoring and management system of claim 21, wherein the message sent to the payor relates to at least one of whether the treatment plan is being performed and complied with or not, whether the treatment plan needs to be altered, and whether the subject is progressing, regressing, success is being or has been achieved based on the analysis, the subject has been put in or logged into a server or system operated by the payor, an evaluation has been performed by a healthcare provider or supervisor, a treatment plan has been prescribed to the subject, status of the subject in relation to the treatment plan, and safety issues that occurred during performance of the treatment plan.

23. A method for movement monitoring and management system, comprising:
receiving sensor data via a communication interface in a server, the sensor data including data related to certain activities, exercises or movements performed by the subject according to a treatment plan,
the server analyzing the sensor data to assess performance with the treatment plan,
the server automatically determining whether the treatment plan is being complied with or not, whether the treatment plan needs to be altered, and whether the subject is progressing, regressing, or a successful outcome is being or has been achieved based on the analysis, and
the server automatically generating and sending at least one message to a supervisor via the communication interface, the message including information related to at least one of whether the treatment plan is being performed and complied with or not, whether the treatment plan needs to be altered, and whether the subject is progressing, regressing, or success is being or has been achieved based on the analysis.

24. The method of claim 1, wherein the sensor data includes data gathered by motion sensors.

25. The method of claim 24, wherein the sensor data includes at least one of range of motion data, distance, repetition data, and timing data.

26. The method of claim 23, wherein the sensor data includes data gathered by physiologic sensors.

27. The method of claim 26, wherein the sensor data includes at least one of heart rate data, blood pressure data, oxygen saturation data, perspiration rate, temperature, pain level, and EMG data.

28. The method of claim 23, wherein the sensor data includes image data captured by a camera.

29. The method of claim 28, wherein the image data comprises at least one of video or still image data.

30. The method of claim 23, wherein the sensor data includes data gathered by a strength sensor.

31. The method of claim 23, wherein determining that an alteration in the treatment plan is needed includes determining whether the subject is ready to advance to a new level within the treatment plan, or whether the subject needs to revert to a previous level within the treatment plan.

32. The method of claim 23, wherein the message indicates that the subject is not performing an activity, exercise or movement correctly.

33. The method of claim 32, wherein the message is related to the subject's posture or position while performing the activity, exercise or movement.

34. The method of claim 32, wherein the message is generated or sent in real-time or near real-time.

35. The method of claim 32, wherein the message is related to the subjects pace or stride while performing an activity, exercise or movement.

36. The method of claim 32, wherein the message is related to the subjects gait or balance while performing an activity, exercise or movement.

37. The method of claim 32, wherein the message is related to the amount of strain the subject is under while performing an activity, exercise or movement.

38. The method of claim 32, wherein the message is related to a range of motion for an activity, exercise or movement performed by the subject.

39. The method of claim 32, wherein the message relates to whether or not the subject's vital signs or other physiological parameters are within an acceptable or optimal range or not.

40. The method of claim 32, wherein the message relates to whether the subject is ready to advance a level in the treatment plan or no or has completed the treatment plan.

41. The method of claim 23, wherein the supervisor is a healthcare provider.

42. The method of claim 23, wherein the subject is logged into or otherwise in communication with a server or system operated by the supervisor, and wherein the message further indicates that the patient is properly logged into or in communication with the server or system operated by the supervisor.

42. The method of claim 23, further comprising the server sending a message to a payor.

44. The method of claim 43, wherein the message sent to the payor relates to at least one of whether the treatment plan is being performed and complied with or not, whether the treatment plan needs to be altered, and whether the subject is progressing, regressing, success is being or has been achieved based on the analysis, the subject has been put in or logged into a server or system operated by the payor, an evaluation has been performed by a healthcare provider or supervisor, a treatment plan has been prescribed to the subject, status of the subject in relation to the treatment plan, and safety issues that occurred during performance of the treatment plan.
